(19) United States
(12) Patent Application Publication
(10) Pub. No.: US 2014/0089430 A1
(43) Pub. Date: Mar. 27, 2014

(54) DATA-SHARING METHOD, TERMINAL, SERVER, AND SYSTEM

(71) Applicant: Tencent Technology (Shenzhen) Company Limited, Shenzhen (CN)

(72) Inventors: Wen Long Luo, Shenzhen (CN); Tian Chen, Shenzhen (CN); Qian Jiang, Shenzhen (CN); Xiao Xiao, Shenzhen (CN)

(73) Assignee: Tencent Technology (Shenzhen) Company Limited, Shenzhen (CN)

(21) Appl. No.: 14/030,974

(22) Filed: Sep. 18, 2013

Related U.S. Application Data
(63) Continuation of application No. PCT/CN2013/079110, filed on Jul. 10, 2013.

(30) Foreign Application Priority Data
Sep. 21, 2012 (CN) 201210355338X

(51) Int. Cl. H04L 12/58

(52) U.S. Cl. CPC H04L 51/046
USPC 709/206

(57) ABSTRACT

Methods, terminals, servers, and systems for sharing data are disclosed. The data-sharing method can include: a first instant messaging terminal transmitting a data-sharing request to a second instant messaging terminal; the second instant messaging terminal responding to the data-sharing request by transmitting a reply permitting data sharing to the first instant messaging terminal, the reply including an identifier (ID) collection of the shareable data resources; the first instant messaging terminal transmitting a data-reading request to the second instant messaging terminal, the data-reading request including at least one data resource ID; the second instant messaging terminal transmitting a data resource corresponding to the data resource ID in the data-reading request to the first instant messaging terminal. This allows simple and fast data-sharing among multiple terminals.

### CROSS REFERENCE TO RELATED APPLICATION

This application is a continuation of International Application No. PCT/CN2013/079110 filed Jul. 10, 2013, which claims the priority benefit of Chinese Patent Application No. 201210355338.X filed Sep. 21, 2012, the content of which is incorporated by reference herein in its entirety for all intended purposes.

### FIELD

This relates generally to the field of communication, and in particular, to a data-sharing method, terminal, server, and system.

### BACKGROUND

As computer and network technologies develop, more and more different types of devices are used by small businesses or at public places. For example, there may be a number of smartphones, personal desktop PCs, laptop PCs, smart TVs, laptop PCs or other devices connected to the same local area network (LAN). There is a need for sharing data among these devices. Existing technology typically requires a wire such as a Universal Serial Bus (USB) to connect multiple terminal devices. Alternatively, data files in the multiple terminal devices can be shared by making a copy on a mobile storage medium. There are a lot of limitations and inconvenience with these mechanisms.

### SUMMARY

One of the technical problems that can be resolved by the embodiments of the present disclosure is to provide a data-sharing method, terminal, server, and system to allow multiple terminals to have each access of data files from each other.

To resolve this technical problem, an embodiment in the first aspect of the disclosure can provide a data-sharing method including the following exemplary steps.

A first instant messaging terminal can transmit a data-sharing request to a second instant messaging terminal, the first instant messaging terminal and the second instant messaging terminal communicating with each other by logging into related accounts of an instant messaging application.

The second instant messaging terminal can respond to the data-sharing request, transmit a reply permitting data sharing, the reply including an ID collection associated with at least one shareable data resource, the ID collection including at least one data resource ID.

The first instant messaging terminal can transmit a data-reading request to the second instant messaging terminal, the data-reading request including at least one data resource ID.

The second instant messaging terminal can transmit to the first instant messaging terminal a data resource corresponding to the at least one data resource ID in the data-reading request.

An embodiment in the second aspect of the disclosure provides a first instant messaging terminal, which can include the following modules.

A terminal interacting module that can interact, via an instant messaging application, with a second instant communication module logged into a related account of the application.

The terminal interacting module can include the following units.

A sharing request unit that can transmit a data-sharing request to the second instant messaging terminal.

A response-obtaining unit that can obtain a response permitting data sharing transmitted from the second instant messaging terminal, the response including an ID collection associated with at least one shareable data resources, the ID collection including at least one data resource ID.

A data-requesting unit that can transmit a data-reading request to the second instant messaging terminal, the data-reading request including at least one data resource ID.

A data-obtaining unit that can obtain a data resource transmitted from the second instant messaging terminal, the data resource corresponding to the data resource ID in the data-reading request.

An embodiment in a third aspect of the disclosure provides a second instant messaging terminal, which can include the following modules.

A terminal-interacting module that can interact, via an instant messaging application, with a first instant messaging terminal logged into a related account of the application.

The terminal-interacting module can include the following units.

A share request obtaining unit that can obtain a data-sharing request transmitted from the first instant messaging terminal.

A reply transmitting unit that can respond to the data-sharing request and transmit a reply permitting data sharing to the first instant messaging terminal, the reply including an ID collection of at least one shareable data resource, the ID collection of the at least one shareable data resource including at least one data resource ID.

A data request obtaining unit that can obtain a data-reading request transmitted from the first instant messaging terminal, the data-reading request including at least one data resource ID.

A data transmitting unit that can transmit, to the first instant messaging terminal, a data resource corresponding to the data resource ID in the data-reading request.

An embodiment in the fourth aspect of the disclosure provides a messaging server, which can include the following modules.

An interaction-routing module that can route information to facilitate an interaction between the first instant messaging terminal and the second instant communication terminal logged into related accounts.

The interaction-routing module can include the following units.

A sharing request routing unit that can forward a data-sharing request transmitted from the first instant messaging terminal to the second instant messaging terminal.

A reply routing unit that can obtain a reply permitting data sharing from the second instant messaging terminal and forward the reply to the first instant messaging terminal, the reply comprising an ID collection of at least one shareable data resource, the ID collection of the at least one shareable data resource including at least one data resource ID.

A data request routing unit that can obtain a data-reading request transmitted from the first instant messaging terminal and forward the data-reading request to the second instant messaging terminal, the data-reading request including at least one data resource ID.

A data routing unit that can obtain the data resource corresponding to the data resource ID in the data-reading request and transmitted from the second instant messaging terminal and forwards the data resource to the first instant messaging terminal.

An embodiment in the fifth aspect of the disclosure provides an instant messaging system for facilitating data sharing. The instant communication system can include the first instant messaging terminal disclosed in the embodiment of the second aspect of the disclosure and the second instant messaging terminal disclosed in the embodiment of the third aspect of the disclosure.

The first instant messaging terminal can transmit a data-sharing request to the second instant messaging terminal; after obtaining a reply permitting data sharing from the second instant messaging terminal, transmit a data-reading request to the second instant messaging terminal, the data-reading request including at least one data resource ID; and obtain a data resource corresponding to the data resource ID in the data-reading request, the data resource transmitted from the second instant messaging terminal.

The second instant messaging terminal can respond to the data-sharing request and transmit the reply permitting data sharing to the first instant messaging terminal, the reply including at least one shareable data resource ID; obtain the data-reading request transmitted from the first instant messaging terminal; and transmit the data resource corresponding to the data resource ID in the data-reading request to the first instant messaging terminal.

The terminals of the embodiments of the present disclosure can interact with each other by logging into related account of an instant messaging application to facilitate accessing and reading data resources. This can provide a faster and easier way of sharing data among the multiple terminals.

### BRIEF DESCRIPTION OF THE DRAWINGS

FIG. 1 is a flowchart illustrating the exemplary steps in a data-sharing method, according to an embodiment of the disclosure.

FIG. 2 is a flowchart illustrating exemplary steps of a data sharing method, according to an embodiment of the disclosure.

FIG. 3 is a flowchart illustrating the exemplary steps of a data-sharing method, according to an embodiment of the disclosure.

FIG. 4 is a block diagram illustrating the exemplary structure of a first instant messaging terminal, according to an embodiment of the disclosure.

FIG. 5 is a block diagram illustrating the exemplary structure of the second instant messaging terminal, according to an embodiment of the disclosure.

FIG. 6 is a block diagram illustrating an exemplary structure of the messaging server, according to an embodiment of the disclosure.

FIG. 7 is a block diagram illustrating an exemplary structure of an instant messaging system for facilitating data sharing, according to an embodiment of the disclosure.

FIG. 8 is a block diagram illustrating an exemplary structure of the instant messaging system, according to another embodiment of the disclosure.

FIG. 9 is block diagram illustrating an exemplary structure of a device control apparatus, according to an embodiment of the present disclosure.

### DETAILED DESCRIPTION

A detailed description of the technical solutions of the embodiments of the present disclosure is provided below in view of the accompanying drawings. It should be understood that the embodiments described below are representative embodiments of the present disclosure rather than a complete disclosure of the every possible embodiment. The present disclosure can also include any other embodiments that can be derived from these disclosed embodiments by a person with ordinary skill in the art without any additional inventive work. It is to be understood that other embodiments can be used and structural changes can be made without departing from the scope of the embodiments of this disclosure.

This disclosure generally relates to data sharing among multiple terminals using a communication application. As referred hereinafter, terminals can be any electronic device capable of communicating with one or more other terminals over a computer network, preferably, a wireless network, for transmitting and/or receiving data. Such devices can include, but are not limited to, PCs, Macs, desktop computers, laptop computers, tablet PCs, smartphones including iPhones, Android phones, Windows phones, and Blackberries, e-readers, in-car communication devices, televisions, gaming consoles and other consumer electronic devices with sufficient network capabilities. Furthermore, the terms “device” and “terminal” are interchangeable terminologies in this disclosure.

The terminals/devices in the embodiments discussed below can have installed on them and run a communication tool or application (the terms “tool” and “application” are interchangeable terminologies in this disclosure) for communicating with one or more other terminals/devices. The communication tool or application can, for example, be an instant messaging application (e.g., MSN messenger by Microsoft or QQ by Tencent) or any other types of messaging applications. In the embodiments described below, a terminal or device can be referred to as a first instant messaging terminal or a second instant messaging terminal, although it should be understood that the first and second instant messaging terminals are not necessarily terminals dedicated for the purpose of sending and receiving instant messages or any other types of messages. That is, the first and second instant messaging terminals can be any devices such as those listed above. They can be general purpose devices (PCs, iPhones) or devices built for particular purposes, so long as they are capable of communicating with one or more other terminals via a communication application.

To share data, one of the terminals (e.g., the first instant messaging terminal) can log into an account of the communication application, such as an instant messaging application and send a data-sharing request to one or more other terminals (e.g., the second instant messaging terminal) requesting to share data one the one or more other terminals. The request and some, if not all, of the communications between the terminals can be through the communication application. The second instant messaging terminal (and/or other terminals) can also be logged into an account of the communication application to receive the request and other communications from the first instant messaging terminal. In some embodiment, the accounts logged into by the requesting terminal (e.g., first instant messaging terminal) and the receiving terminal (e.g., second instant messaging terminal) can be the same account. For example, a user may have two devices (e.g., an iPhone and a MAC), both running an instant messaging application. The user can be logged into the same instant messaging account on both of these devices to share data on one of the devices with the other device. Alternatively, the terminals can log into different, but related accounts of the communication application. The related accounts can be accounts that are designed as “friends” with respect to each other or are members of the same public or private group. This allows friends and/or users in the same social group to share data from their respective devices using the methods, terminals, and systems disclosed herein.

In the various embodiments discussed below. The same terminal can be both a terminal requesting data from another terminal and a terminal from which data can be requested. Data stored on a terminal can be referred to as one or more data resources. A data resource can include any type of data, such as image, text, audio, video, and any other multimedia data stored on a user device. The second instant messaging terminal, after receiving the data-sharing request, can send a reply back to the first instant messaging terminal either granting or denying the request. If the request is granted, the second instant messaging terminal can also send one or more IDs identifying one or more data resources on the second instant messaging terminal that are available for sharing. The IDs can be included in the reply and transmitted to the first instant messaging terminal via the communication application. The IDs of the available data resources can then be displayed on the first instant messaging terminal to allow the user to select the desirable data resource(s) to be obtained from the second instant messaging terminal. The first instant messaging terminal can then send a data-reading request including the selected data resource IDs to the second instant messaging terminal. Based on these IDs, the second instant messaging terminal can transmit the corresponding data resources to the first instant messaging terminal. The data-reading request and/or the corresponding data resources can also be transmitted via the communication application. Alternatively, the data resources can, for example, be transmitted via a different application. In some embodiments, the data can be automatically displayed using a suitable application on the first instant messaging terminal when it is received. For example, a data resource that is a video clip can be automatically played using a multimedia application on the terminal.

As described in the embodiments below, in operation, the terminals (e.g., the first and second instant messaging terminal) can be connected to each other via a network. The network can be any computer network such as the Internet, a LAN, wide area network (WAN), cellular network, Wi-Fi network, and virtual private network (VPN). Preferably, the connection can be wireless in some embodiments.

In some embodiments, the terminals can connect to each other directly and communicate with each other without going through a server. For example, when the terminals can connect to each other directly when they are connected to the same network, (e.g., the same LAN or Wi-Fi spot) or when they are connected directly to each other via, for example, a Bluetooth connection. If the terminals cannot connect to each other directly, they can communicate through a messaging server (e.g., an instant messaging server such as a QQ server provided by Tencent for supporting the QQ instant messaging application). For example, when the first and second instant messaging terminals are connected to two different networks (e.g., LANs) or direct communication is block by a firewall, some or all of the communications between the first and second instant messaging terminals can be routed through a messaging server. In some embodiments, to determine whether two or more terminals can connect to each other directly, each of the terminals can upload their gateway device information to a server, which can then determine, based on the gateway device information, whether the terminals can connect to each other directly.

In some embodiments, if the communication application is not in an active mode on a terminal (e.g., if the application is running in the background while another application is running in the foreground), the messaging server may first send a message (e.g., a push message) to the terminal to activate the communication application (e.g., move it to the foreground) before forwarding a data request to the terminal. This can request the messaging server to obtain an operating status of the communication application on the terminal before forwarding any communication to the terminal.

In the embodiments of the present disclosure, an instant messaging terminal can be a personal computer (PC), mobile phone, tablet PC, smartphone, e-reader, laptop computer, in-car terminal, or any other network-enabled device.

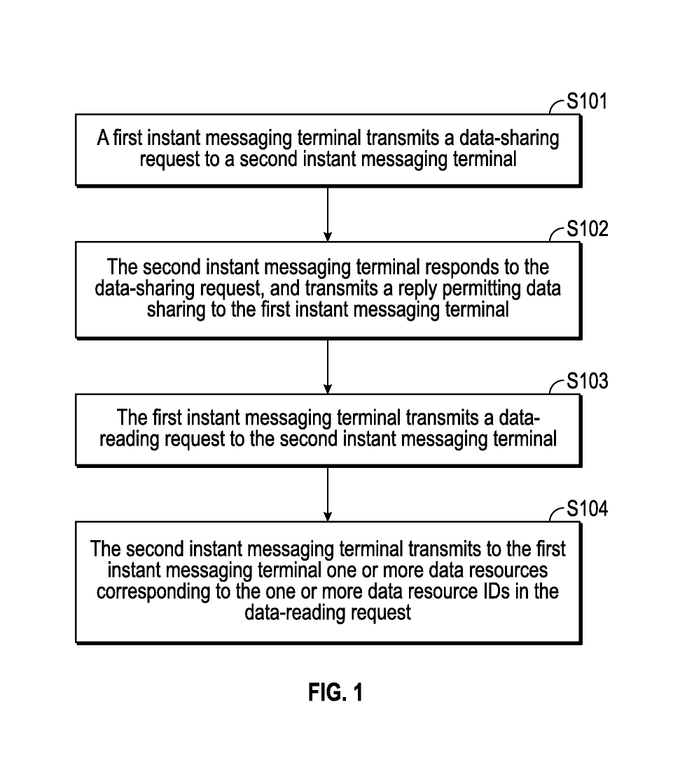

FIG. 1 is a flowchart illustrating the exemplary steps in a data-sharing method, according to a first embodiment of the disclosure. The data-sharing method in the illustrated embodiment can include the following steps.

S101: A first instant messaging terminal can transmit a data-sharing request to a second instant messaging terminal. The first instant messaging terminal and the second instant messaging terminal can interact with each other by logging into related accounts of an instant messaging application. In particular, in this embodiment, the first instant messaging terminal and the second instant messaging terminal can be two network devices on the same LAN. The terminals can discover each other as terminals logged into the related accounts on the LAN by having one of the terminals broadcasting a discovery message over the LAN. The related accounts can be friends with respect to each other or members of a particular group. They can also be the same instant messaging account logged in at different terminals.

S102: The second instant messaging terminal can respond to the data-sharing request, and transmit a reply permitting data sharing to the first instant messaging terminal. The reply permitting data sharing can include an ID collection of one or more shareable data resources. In particular, the second instant messaging terminal, after receiving the data-sharing request, can display a message prompting whether or not to grant the data-sharing request. It can respond to the data-sharing request based on a user input selection. If the user chooses to reject the request, the second instant messaging terminal can send a reply to the first instant messaging terminal rejecting the request and the process can end. If the user chooses to allow data sharing, the second instant messaging terminal can send a reply to the first instant messaging terminal granting the request. The reply granting data sharing can include an ID collection of one or more shareable data resources, which can include at least one data resource ID. The data resource ID can be an ID of a data resource at the second instant messaging terminal that can be shared with the first instant messaging terminal or any other terminals. The user can manually designate a data resource, a type of data resources, or a folder of data resources as shareable data resources. The second instant messaging terminal can generate a corresponding data resource ID of a shareable data resource. The data resource ID can be of a format including, for example, the name, abstract, attribute, or thumbnail associated with the data resource. The ID collection of the one or more shareable data resources can include a list including multiple data resource IDs.

S103: The first instant messaging terminal can transmit a data-reading request to the second instant messaging terminal. The data-reading request can include at least one data resource ID. In particular, after the first instant messaging terminal receives the reply from the second instant messaging terminal, the first instant messaging terminal can display the ID collection of the one or more shareable data resources in the reply to prompt a user at the first instant messaging terminal to select one or more desirable data resources to be obtained. After receiving a selection command from the user, the first instant messaging terminal can transmit a data-reading request to the second instant messaging terminal. The data-reading request can include at least one data resource ID.

S104: The second instant messaging terminal can transmit to the first instant messaging terminal one or more data resources corresponding to the one or more data resource IDs in the data-reading request. This can allow the first instant messaging terminal to obtain data via an instant messaging application from the second instant messaging terminal logged into a related account.

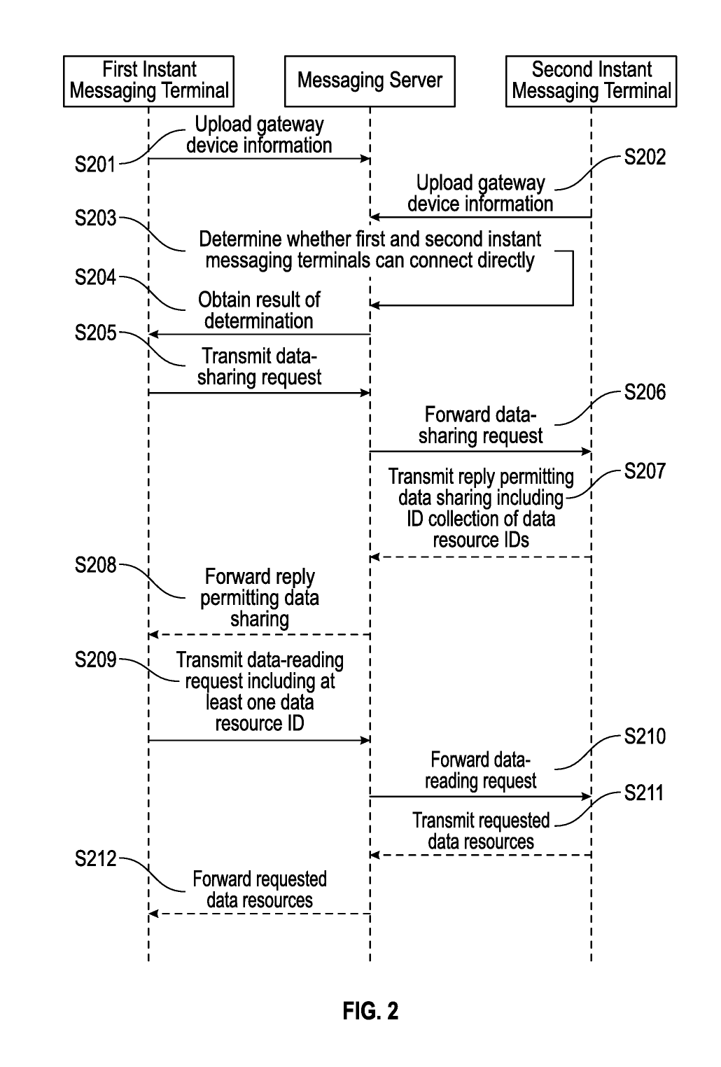

FIG. 2 is a flowchart illustrating exemplary steps of a data sharing method, according to a second embodiment of the disclosure. In this embodiment, the first instant messaging terminal and the second instant messaging terminal logged into a related account are not connected to the same LAN. The terminals can discover each other through a server. The illustrated instant messaging method in this embodiment can include the following process.

S201, S202: The first instant messaging terminal and the second instant messaging terminal can each upload their respective gateway device information to a messaging server. In operation, the first instant messaging terminal and the second instant messaging terminal can transmit their respective gateway device information to the messaging server on a regular basis using an instant messaging application after logging into their instant messaging accounts. The gateway device information can include unique identification information (e.g., MAC addresses) of the gateway devices (e.g., routers) of the first and second instant messaging terminals on their respective LANs or their respective IP addresses on a public network.

S203: The messaging server can determine whether the first instant messaging terminal and the second instant messaging terminal can connect directly to each other. In operation, the messaging server can determine, based on the gateway device information of each terminal, whether the two terminals belong to the same LAN. If they do, it can be determined that the two terminals can connect directly with each other.

S204: The first instant messaging terminal can obtain the result of the determination from the messaging server. In operation, when the user needs to transfer an instant messaging screen from the first instant messaging terminal to the second instant messaging terminal, the determination of whether the first instant messaging terminal and the second instant messaging terminal can connect directly with each other can be first obtained. When the first instant messaging terminal and the second instant messaging terminal can connect directly with each other, steps S101-S104 in the first embodiment can be executed. When the first instant messaging terminal and the second instant messaging terminal cannot connect directly, S205 below can be executed.

S205: The first instant messaging terminal can transmit to the messaging server a data-sharing request directed to the second instant messaging terminal.

S206: The messaging server can forward the data-sharing request from the first instant messaging terminal to the second instant messaging terminal.

S207: The second instant messaging terminal can respond to the data-sharing request and transmit a reply permitting the request to the messaging server. The reply permitting data sharing can include an ID collection of one or more shareable data resources. In particular, the second instant messaging terminal, after receiving the data-sharing request, can display a message prompting whether or not to grant the data-sharing request. It can respond to the data-sharing request based on a user input selection. If the user chooses to reject the request, the second instant messaging terminal can send a reply to the first instant messaging terminal rejecting the request. If the user chooses to allow data sharing, the second instant messaging terminal can send a reply to the first instant messaging terminal granting the request. The reply permitting data sharing can include an ID collection of one or more shareable data resources, which can include at least one data resource ID. The data resource ID can be an ID of a data resource at the second instant messaging terminal that can be shared with the first instant messaging terminal or any other terminals. The user can manually set a data resource, a type of data resources, or a folder of data resources as shareable data resources. The second instant messaging terminal can generate a corresponding data resource ID based on a shareable data resource. The data resource ID can be of a format including, for example, the name, abstract, attribute, or thumbnail associated with the data resource. The ID collection of shareable data resources can include a list including multiple data resource IDs.

S208: The messaging server can forward the reply permitting data sharing from the second instant messaging terminal to the first instant messaging terminal.

S209: The first instant messaging terminal can transmit to the messaging server a data-reading request directed to the second instant messaging terminal. The data-reading request can include at least one data resource ID. In particular, the first instant messaging terminal, after receiving the reply from the second instant messaging terminal, can display the ID collection of the one or more shareable data resources in the reply to prompt the user at the first instant messaging terminal to select one or more data resources to be obtained. After receiving a selection command from a user, the first instant messaging terminal can transmit a data-reading request to the messaging server. The data-reading request can include at least one data resource ID selected by the user.

S210: The messaging server can forward the data-reading request from the first instant messaging terminal to the second instant messaging terminal.

S211: The second instant messaging terminal can transmit to the messaging server one or more data resources corresponding to the at least one data resource ID in the data-reading request.

S212: The messaging server can forward the at least one data resource transmitted from the second instant messaging terminal to the first instant messaging terminal. This can allow the first instant messaging terminal to obtain one or more data resources from the second instant messaging terminal by routing information through the messaging server, when the first instant messaging terminal and the second instant messaging terminal cannot connect directly to each other.

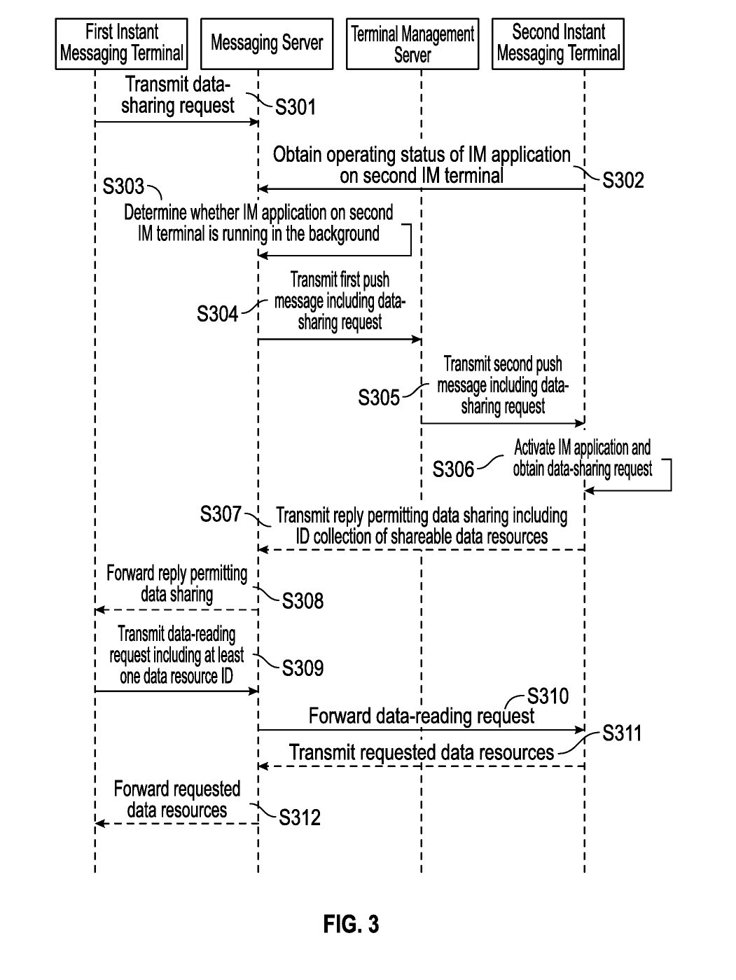

FIG. 3 is a flowchart illustrating the exemplary steps of a data-sharing method, according to a third embodiment of the disclosure. The illustrated data-sharing method of this embodiment can include the following steps.

S301: A messaging server can obtain, from a first instant messaging terminal, a data-sharing request directed to a second instant messaging terminal. In particular, because both the first instant messaging terminal and the second instant messaging terminal can be both logged into their respective instant messaging accounts, the data-sharing request transmitted from the first instant messaging terminal to the second instant messaging terminal using the instant messaging application can be obtained by the messaging server. The instant messaging application can be running in the background at the second instant messaging terminal. Therefore, it may not obtain the data-sharing request directly from the first instant messaging terminal and, instead, requires the messaging server to obtain and then forward the data-sharing request.

S302: The messaging server can obtain the operation status information of the instant messaging application at the second instant messaging terminal. In operation, the second instant messaging terminal can transmit the operation status information of its instant messaging application to the messaging server on a regular basis. Alternatively, it can also transmit the operating status information of its instant messaging application to the messaging server when there is a change to the operating status of the instant messaging application to notify the messaging server about the latest operating status.

S303: The messaging server can determine whether the instant messaging application at the second instant messaging terminal is running in the background. In operation, after the messaging server obtains, from the first instant messaging terminal, the data-sharing request directed to the second instant messaging terminal, the messaging server can determine, based on the latest operating status information of the instant messaging application uploaded from the second instant messaging terminal, whether the instant messaging application at the second instant messaging terminal is running in the background. When it is determined that the instant messaging application at the second instant messaging terminal is not running in the background, the messaging server can proceed as described in the previous two embodiments to process the data-sharing request. For example, it can determine whether the first instant messaging terminal and the second instant messaging terminal can connect directly with each other based on the gateway device information of the first and second instant messaging terminals. If they can, the data-sharing request can arrive at the second instant messaging terminal directly, and then the remaining process described in the first embodiment can be carried out. If the first instant messaging terminal and the second instant messaging terminal cannot connect directly, the messaging server can forward the received data-sharing request to the second instant messaging terminal to execute the process described in the second embodiment. When it is determined that the instant messaging application at the second instant terminal is running in the background, step S304 can be carried out.

S304: The messaging server can transmit to a terminal management server associated with the second instant messaging terminal a first push message including the data-sharing request. The terminal management server associated with the second instant messaging terminal can be, for example, an Apple terminal management server. The messaging terminal can transmit the first push message including the data-sharing request to the Apple terminal management server, requesting the Apple terminal management server to wake up a second instant messaging terminal under its management. The second instant messaging terminal can include, for example, an iPhone or iPad (i.e., smartphones and tablet PCs from Apple, both using iOS system)

S305: The terminal management server associated with the second instant messaging terminal can transmit a second push message including the data-sharing request to the second instant messaging terminal based on the first push message transmitted from the messaging server.

S306: The second instant messaging server can activate its instant messaging application in response to receiving the second push message and obtain the data-sharing request from the second push message.

S307-S312 can be the same as S207-S212 of the above-described second embodiment, respectively.

This embodiment can resolve the problem when the instant messaging application at the second instant messaging terminal is running in the background and cannot receive the data-sharing request from the first instant messaging terminal.

The embodiments of the disclosure also disclose a non-transitory computer-readable medium storing a program, when executed, can perform some or all of the steps in the embodiments disclosed above in view of FIGS. 1-3.

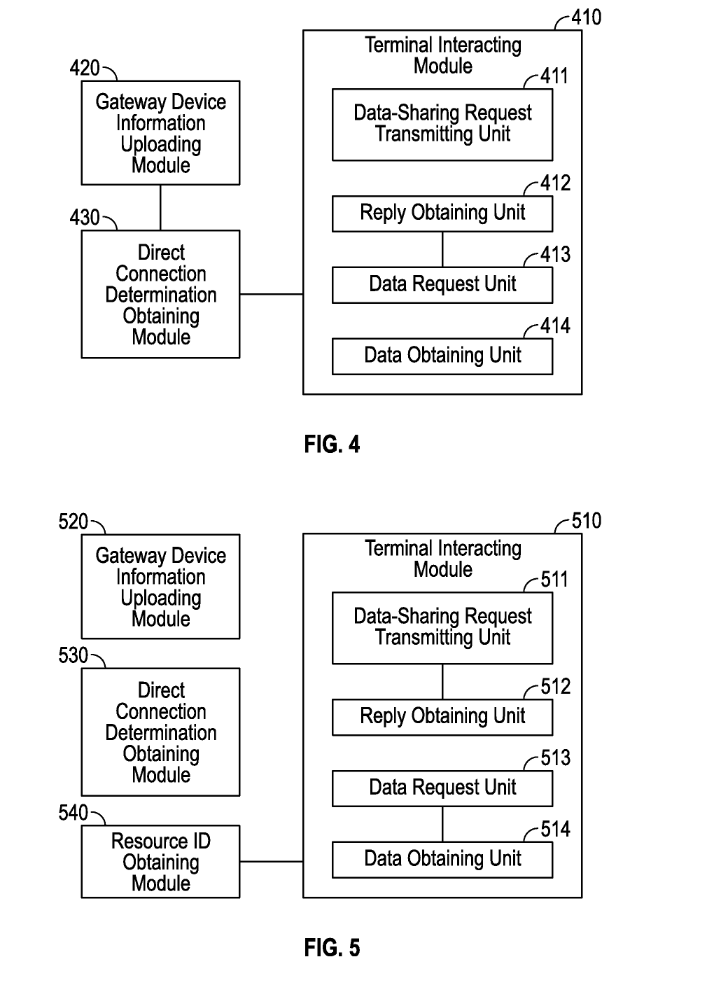

FIG. 4 is a block diagram illustrating the exemplary structure of a first instant messaging terminal, according to an embodiment of the disclosure. The first instant messaging terminal in this embodiment can be a PC, mobile phone, tablet PC, smartphone, e-reader, laptop PC, in-car terminal or other network-enabled device. The first instant messaging terminal, as illustrated, can include at least the following components.

A terminal interacting module 401 that can interact with a second instant messaging terminal logged into a related account via an instant messaging application. In particular, the related account can be of an account of a friend or another member of a particular common group. It can also be the same account logged into at a different instant messaging terminal. The terminal interacting module 410 can interact with the second instant messaging terminal directly or by routing information through a messaging server. For example, in this embodiment, when the first instant messaging terminal and the second instant messaging terminal have already discovered each other, the terminal interacting module 410 can interact with the second instant messaging terminal directly. Alternatively, the first instant messaging terminal can obtain from the messaging server the result of determining whether a direct connection to the second instant messaging terminal can be established. Based on the result, it can then be determined whether the terminal interacting module 410 can interact directly with the second instant messaging terminal or it has to interact with the second instant messaging terminal by routing information through the messaging server.

The terminal interacting module can include the following units.

A sharing request transmitting module 411 that can transmit a data-sharing request to the second instant messaging terminal.

A reply obtaining unit 412 that can obtain a reply permitting data sharing from the second instant messaging terminal. The reply can include an ID collection of one or more shareable data resources. The ID collection of the shareable data resources can include at least one data resource ID. In particular, after the second instant messaging terminal receives the data-sharing request from the sharing request transmitting unit 411, the second instant messaging terminal can display information prompting whether to grant the data sharing request. The second instant messaging terminal can choose whether or not to grant the data sharing request based on user input. If the user chooses not to grant the request, the second instant messaging terminal can transmit, to the first instant messaging terminal, a reply denying the data-sharing request. If the user chooses to accept the request, the second instant messaging terminal can transmit, to the first instant messaging terminal, a reply permitting the data-sharing request. The reply obtaining module 412 can then obtain the reply permitting the sharing request transmitted from the second instant messaging terminal. The reply permitting the sharing request can include an ID collection of the one or more shareable data resources, which includes at least one data resource ID. A data resource ID can be an identification of a data resource at the second instant messaging terminal that can be shared with the first instant messaging terminal or any other terminals. The user can manually set a data resource, a type of data resources, or a folder of data resources as shareable data resources. The second instant messaging terminal can generate a corresponding data resource ID based on a shareable data resource. The data resource ID can be of a format including, for example, the name, abstract, attribute, or thumbnail associated with the data resource. The ID collection of shareable data resources can include a list including multiple data resource IDs.

A data request unit 413 that can transmit a data-sharing request to the second instant messaging terminal. The data-reading request can include at least one of the data resource ID. In particular, after the reply obtaining unit 412 receives the reply from the second instant messaging terminal, the first instant messaging terminal can display the ID collection of the shareable data resources in the reply to prompt a user at the first instant messaging terminal to select one or more desirable data resources to be obtained. After receiving a selection command from the user, the data request unit 413 can transmit a data-reading request to the second instant messaging terminal. The data-reading request can include at least one data resource ID.

A data obtaining unit 414 that can obtain the one or more data resources corresponding to the one or more data resource IDs in the data-reading request, the one or more data resources transmitted from the second instant messaging terminal.

Optionally, the first instant messaging terminal can further include the following modules.

A gateway device information uploading module 420 that can upload gateway device information of the first instant messaging terminal to the messaging server. In particular, the gateway device information of the first instant messaging terminal can include unique identification information (e.g., MAC addresses) of the gateway devices (e.g., routers) of the first and second instant messaging terminals on their respective LANs or IP addresses on a public network.

A direct connection determination obtaining module 430 that can obtain the determination regarding whether the first instant messaging terminal and the second instant messaging terminal can connect directly to each other. In operation, the messaging server can determine, based on the gateway device information of each terminal, whether the two terminals belong to the same LAN. If so, it can be determined that the two terminals can interact directly with each other. The direct connection determination obtaining module 430 can obtain from the server the result of whether the first instant messaging terminal and the second instant messaging terminal can connect directly to each other. When the first instant messaging terminal and the second instant messaging terminal can connect directly, the terminal interacting module 410 can interact with the second instant messaging terminal directly. When the first instant messaging terminal cannot connect directly to the second instant messaging terminal, the terminal interacting module 410 can interact with the second instant messaging terminal by routing information through a messaging server.

FIG. 5 is a block diagram illustrating the exemplary structure of the second instant messaging terminal, according to an embodiment of the disclosure. In this embodiment, the second instant messaging terminal can be a PC, mobile phone, tablet PC, smartphone, e-reader, laptop computer, in-car terminal or any other network-enabled device. The second instant messaging terminal in the illustrated embodiment can include at least the following modules.

A terminal interacting module 510 that can interact, via an instant messaging application, with a first instant messaging terminal logged into a related account. In particular, the related account can be account of a friend of another member of the same group. It can also be the same account logged in at different instant messaging terminals. The terminal interacting module 510 can connect to the first instant messaging terminal directly or by routing information through a messaging server. For example, in this embodiment, when the first instant messaging terminal and the second instant messaging terminal discover each other in the same LAN, the terminal interacting module 510 can connect to the first instant messaging terminal directly to interact with each other.

The terminal-interacting module can include the following units.

A sharing request obtaining unit 511 that can obtain the data-sharing request transmitted from the first instant messaging terminal.

A reply transmitting unit 512 that can respond to the data-sharing request, and transmit a reply permitting data sharing to the first instant messaging terminal. The reply permitting data sharing can include an ID collection of one or more shareable data resources. The ID collection can include at least one data source ID. In particular, the sharing request obtaining unit 511, after receiving the data-sharing request, can display a message on a display of the second instant messaging terminal prompting whether or not to grant the data-sharing request. The reply transmitting unit 512 can respond to the data-sharing request based on a user input selection. If the user chooses to reject the request, the reply transmitting unit 512 can send a reply to the first instant messaging terminal rejecting the request. If the user chooses to allow data sharing, the reply transmitting unit 512 can send a reply to the first instant messaging terminal granting the request. The reply granting data sharing can include an ID collection of shareable data resources, which can include at least an ID of one data resource. The data resource ID can be an ID of a data resource at the second instant messaging terminal that can be shared with the first instant messaging terminal or any other terminals. The user can manually set a data resource, a type of data resources, or a folder of data resources as shareable data resources. The second instant messaging terminal can generate a corresponding data resource ID based on a shareable data resource. The data resource ID can be of a format including, for example, the name, abstract, attribute, or thumbnail associated with the data resource. The ID collection of shareable data resources can include a list including multiple data resource IDs.

A data request obtaining unit 513 that can obtain a data-sharing request transmitted from the first instant messaging terminal. The data-sharing request can include at least one of the data resource IDs. In particular, the first instant messaging terminal can display on its display the ID collection of the one or more shareable data resources in the reply, after receiving the reply transmitted from the reply transmitting unit 512, to prompt a user at the first instant messaging terminal to choose one or more of the data resources to obtain. After receiving the user's selection command, the first instant messaging terminal can transmit a data-sharing request to the second instant messaging terminal. The data request obtaining unit 513 can obtain the data-sharing request transmitted from the first instant messaging terminal. The request can include the at least one data resource ID selected by the user at the first instant messaging terminal.

A data transmitting unit 514 that can transmit, to the first instant messaging terminal, one or more data resources corresponding to the at least one data resource ID in the data-sharing request.

Optionally, the second instant messaging terminal of this embodiment can also include one or more of the following modules.

A gateway device information uploading module 520 that can upload the gateway device information of the second instant messaging terminal to the messaging server to allow the messaging server to determine whether, based on the gateway device information of the first and second instant messaging terminals, the first instant messaging terminal and the second instant messaging terminal can connection to each other directly. In particular, the gateway device information of the second instant messaging terminal can be unique identification information (e.g., an MAC address) of the gateway device (e.g., a router) on the LAN or a public IP address. The messaging server can determine based on the gateway device information whether the two terminals belong to the same LAN. If they do, it can be determined that the two terminals can connect directly to each other. When the first instant messaging terminal and the second instant messaging terminal can connect directly to each other, the terminal interacting module 510 can interact with the first instant messaging terminal directly. When the first instant messaging terminal and the second instant messaging terminal cannot connect directly, the terminal interacting module 510 can interact with the first instant messaging terminal by routing information through the messaging server.

Optionally, the second instant messaging terminal in this embodiment can include the following modules.

An operating status uploading module 530 that can transmit to the messaging server operating status information of the instant messaging application, which can allow the messaging server to determine whether the instant messaging application on the instant messaging terminal is running in the background. In operation, the operating status uploading module 530 can transmit to the messaging server the operating status information of its instant messaging application on a regular basis. Alternatively, it can also transmit the operating status information of its instant messaging application to the messaging server when there is a change to the operating status of the instant messaging application to notify the messaging server regarding the latest operating status.

The sharing request obtaining unit 511 can include the following units.

A push message obtaining unit that can obtain a second push message transmitted from the terminal management server based on a first push message transmitted from the messaging server to the terminal management server. The first push message and the second push message can both include the data-sharing request transmitted from the first instant messaging terminal. In one embodiment, the terminal management server associated with the second instant messaging terminal can be, for example, an Apple terminal management server. The messaging terminal can transmit the first push message including the data-sharing request to the Apple terminal management server, requesting the Apple terminal management server to wake up the second instant messaging terminal managed by the Apple terminal management server. Then, the terminal management server associated with the second instant messaging server can transmit, based on the first push message transmitted from the messaging server, a second push message including the data-sharing request to the second instant messaging terminal. The push message obtaining unit can receive the second push message transmitted from the terminal management server. The second instant messaging terminal can include, for example, an iPhone or iPad (i.e., smartphones and tablet PCs from Apple, both using iOS system).

An activation unit that can activate the instant messaging application in response to the second push message and obtain the data-sharing request in the second push message.

Optionally, the second instant messaging terminal can also include one or more of the following modules.

A resource ID obtaining module 540 that can obtain an ID collection of one or more shareable data resources based on the data resources designated t by the user as shareable data resources. The data resource ID can be an ID for a data resource at the second instant messaging terminal that is shareable with the first instant messaging terminal or all other terminals. The user can manually set a data resource, a type of data resources, or a folder of data resources as shareable data resources. The resource ID obtaining module 540 can generate a corresponding data resource ID based on a shareable data resource. The data resource ID can be of a format including, for example, the name, abstract, attribute, or thumbnail associated with the data resource. The ID collection of shareable data resources can include a list including multiple data resource IDs.

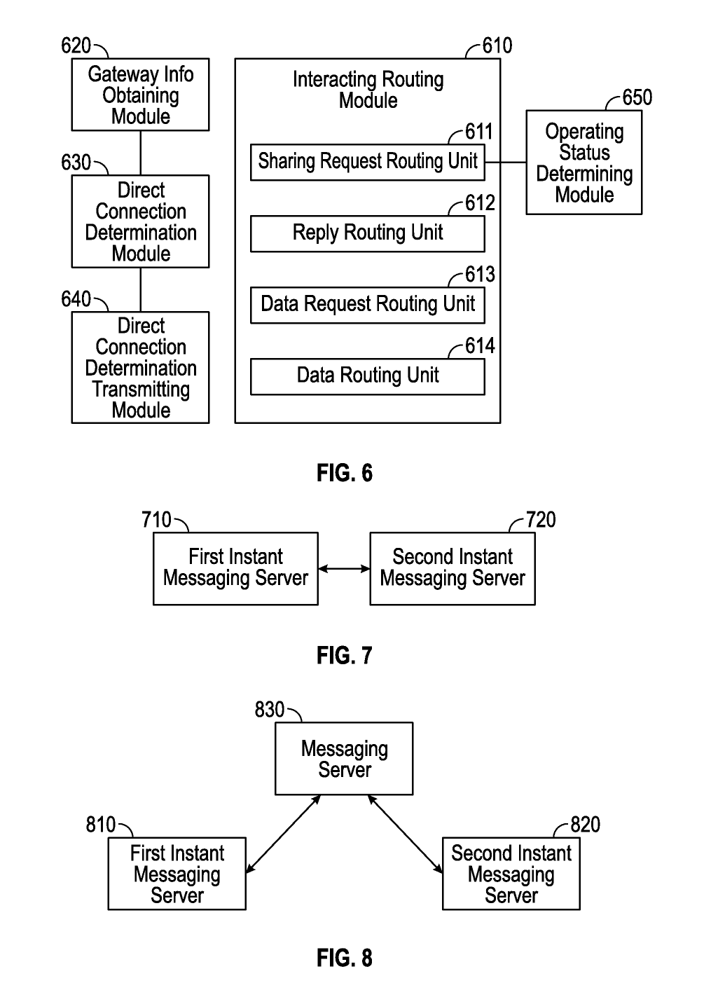

FIG. 6 is a block diagram illustrating an exemplary structure of the messaging server, according to an embodiment of the disclosure. The messaging server in the illustrated embodiment can include at least the following modules.

An interaction routing module 610 that can route information to facilitate the interactions between a first instant messaging terminal and a second instant messaging terminal logged into related accounts. The interaction routing module 610 can include the following units.

A sharing request routing unit 611 that can obtain the data-sharing request transmitted from the first instant messaging terminal and forward it to the second instant messaging terminal.

A reply routing unit 612 that can obtain a reply permitting data sharing from the second instant messaging terminal and forward it to the first instant messaging terminal. The reply permitting data sharing can include an ID collection of one or more shareable data resources. The ID collection of the shareable data resources can include at least one data resource ID.

A data request routing unit 613 that can obtain a data-reading request transmitted from a first instant messaging terminal and forward it to the second instant messaging terminal. The data-reading request can include at least one of the data resource IDs.

A data routing unit 614 that can obtain, from the second instant messaging terminal, a data resource corresponding to the data resource ID in the data-reading request and forward it to the first instant messaging terminal.

Optionally, the messaging server in this embodiment can also include the following modules.

A gateway device information obtaining module 620 that obtains the gateway device information uploaded by the first instant messaging terminal and the second instant messaging terminal. In operation, the first instant messaging terminal and the second instant messaging terminal can transmit their respective gateway device information to the messaging server on a regular basis via an instant messaging application after logging into their respective instant messaging accounts. The gateway device information can be unique identification information (e.g., an MAC address) of the gateway device (e.g., a router) on the LAN or a public IP address.

A direct connection determination module 630 that can determine whether the first instant messaging terminal and the second instant messaging terminal can connect directly based on the gateway device information of the first instant messaging terminal and the second instant messaging terminal. In operation, the direct connection determination module 630 can determine whether the two terminals belong to the same LAN based on their respective gateway device information. If they do, it can be determined that the two terminals can connect directly.

A direct connection determination transmitting module 640 that can transmit, to the first instant messaging terminal, the determination result of whether the first instant messaging terminal and the second instant messaging terminal can connect directly to each other, thereby allowing the first instant messaging terminal to choose whether to connect directly to the second instant messaging terminal or by routing information through the messaging server in order to interact with the second instant messaging terminal.

Optionally, the messaging server in this embodiment can also include the following modules.

An operating status determining module 650 that can obtain the operating status of the instant messaging application at the second instant messaging terminal and determine, based on the obtained operating status, whether the instant messaging application at the second instant messaging terminal is running in the background.

The sharing request routing unit 611 can further include the following units.

A routing request obtaining unit that can obtain the data-sharing request transmitted from the first instant messaging terminal and directed to the second instant messaging terminal.

A push message transmitting module that, when the operating status determining module 670 determines that the instant messaging application of the second instant messaging terminal is running in the background, can transmit a first push message including the data-sharing request to the terminal management server. This can allow the terminal management server to transmit a second push message including the data-sharing request to the second instant messaging terminal based on the first push message, and eventually allow the second instant messaging to activate the instant messaging application in response to the second push message and obtain the data-sharing request. The terminal management server associated with the second instant messaging terminal can be, for example, an Apple terminal management server. The push message transmitting unit can transmit the first push message including the data-sharing request to the Apple terminal management server based on the data-sharing request directed to the second instant messaging terminal and transmitted from the first instant messaging terminal, requesting the Apple terminal management server to wake up the second instant messaging terminal managed by the Apple terminal management server. Then, the terminal management server associated with the second instant messaging server can transmit, based on the first push message transmitted from the messaging server, a second push message including the data-sharing request to the second instant messaging terminal. Finally, the second instant messaging terminal can activate the instant messaging application based on the second push message and obtain the data-sharing request in the second push message. The second instant messaging terminal can include, for example, an iPhone or iPad.

FIG. 7 is a block diagram illustrating an exemplary structure of an instant messaging system for facilitating data sharing, according to an embodiment of the disclosure. The instant messaging system in the illustrated embodiment can include a first instant messaging terminal 710 and a second instant messaging terminal 720.

The first instant messaging terminal 710 can be the first instant messaging terminal described above in view of FIG. 4. It can be for transmitting a data-sharing request to the second instant messaging terminal 720 logged into a related account. After obtaining a reply permitting data sharing from the second instant messaging terminal 720, the first instant messaging terminal 710 can transmit a data-reading request to the second instant messaging terminal 720 based on the ID collection of the shareable data resources in the reply permitting data sharing, and obtain a data resource corresponding to the data resource ID in the data-reading request from the second instant messaging terminal 720.

The second instant messaging terminal 720 can be the second instant messaging terminal as described above in view of FIG. 5. It can be used for obtaining the data-sharing request from the first instant messaging terminal 710 and transmitting a reply permitting data sharing to the first instant messaging terminal 710. The reply can include an ID collection of one or more shareable data resources. It can also obtain the data-reading request transmitted from the first instant messaging terminal and transmit, to the first instant messaging terminal, one or more data resources corresponding to the at least one data resource ID in the data-reading request.

FIG. 8 is a block diagram illustrating an exemplary structure of the instant messaging system, according to another embodiment of the disclosure. The instant messaging system as illustrated in FIG. 8 can include, for example, a first instant messaging terminal 810, a second instant messaging terminal 820, and a messaging server 830.

The first instant messaging terminal 810 can transmit a data-sharing request through the messaging server 830 to the second instant messaging terminal 820 logged into the same instant messaging application. After obtaining a reply permitting data sharing from the second instant messaging terminal 820 through the messaging server 830, the first instant messaging terminal 810 can transmit, via the messaging server 830, a data-reading request to the second instant messaging terminal 820 based on the ID collection of the one or more shareable data resources in the reply. The first instant messaging terminal 810 can also obtain, via information routing by the messaging server 830, the data resource corresponding to the data resource ID in the data-reading request and transmitted from the second instant messaging terminal 820.

The second instant messaging terminal 820 can obtain the data-sharing request transmitted from the first instant messaging terminal 810 through the messaging server 830. It can transmit a reply permitting data share to the first instant messaging terminal 810 through the messaging server 830. The reply can include an ID collection of one or more shareable data resources. It can obtain the data-reading request transmitted from the first instant messaging terminal 810 through the messaging server 830. It can transmit, through the messaging server 830, one or more data resources corresponding to the at least data resource ID in the data-reading request to the first instant messaging terminal 710.

The messaging server 830 can be used for routing information to facilitate interactions between the first instant messaging terminal 810 and the second instant messaging terminal 820 logged into related accounts.

The embodiments of the disclosure can facilitate accessing and reading data resources through logging into related accounts of an instant messaging application, thereby making data sharing among multiple terminals easier and faster.

Based on the above-described embodiments, a person skilled in the art can understand that parts of or the whole process described in each of the above embodiments can be performed by hardware in accordance with instructions from one or more computer programs. The one or more computer programs can be stored in a non-transitory readable medium, and when executed, perform the processes described in these embodiments. The non-transitory computer readable medium can be a floppy disk, CD, read-only memory (ROM), or random access memory (RAM).

In some embodiments, one or more of the modules in FIGS. 4-8 can be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this file, a “non-transitory computer-readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

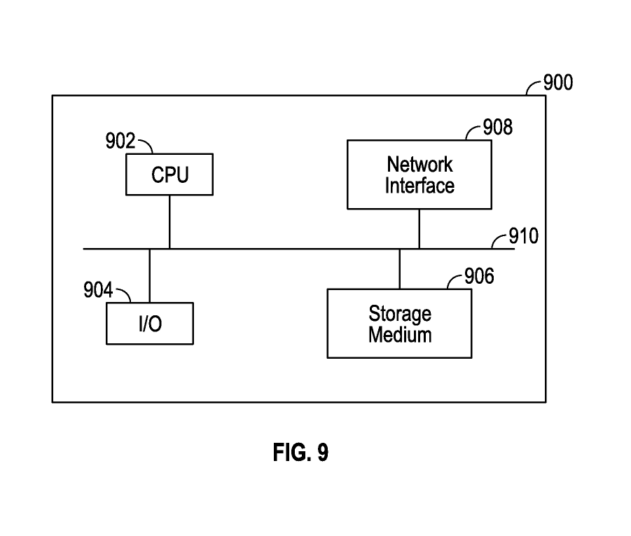

The non-transitory computer readable storage medium can be part of a computing system serving as the device control apparatus. FIG. 9 illustrates exemplary common components of one such computing system. As illustrated, the system 900 can include a central processing unit (CPU) 902, I/O components 904 including, but not limited to one or more of display, keypad, touch screen, speaker, and microphone, storage medium 906 such as the ones listed in the last paragraph, and network interface 908, all of which can be connected to each other via a system bus 910. The storage medium 906 can include the modules of FIGS. 4-8 if the system is a device control apparatus in one of the embodiments discussed above.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A first instant messaging terminal, comprising:
a terminal interacting module that interacts, via an instant messaging application, with a second instant messaging terminal logged into a related account of the application,
the terminal interacting module comprising:
a sharing request unit that transmits a data-sharing request to the second instant messaging terminal,
a response-obtaining unit that obtains a response permitting data sharing transmitted from the second instant messaging terminal, the response comprising an ID collection associated with at least one shareable data resources, the ID collection comprising at least one data resource ID,
a data-requesting unit that transmits a data-reading request to the second instant messaging terminal, the data-reading request comprising at least one data resource ID,
a data-obtaining unit that obtains a data resource transmitted from the second instant messaging terminal, the data resource corresponding to the data resource ID in the data-reading request.

2. The first instant messaging terminal of claim 1, wherein an interaction between the terminal interacting module and the second instant messaging terminal via the instant messaging application can be direct or routed through a messaging server.

3. The first instant messaging terminal of claim 2, comprising:
a gateway device information uploading module that uploads gateway device information of the first instant messaging terminal to the messaging server,
a direct connection determination obtaining module that obtains a determination made by the messaging server regarding whether the first instant messaging terminal and the second instant messaging terminal can connect directly to each other, the determination made based on the gateway device information of the first instant messaging terminal and the second instant messaging terminal,
when the first instant messaging terminal can connect to the second instant messaging terminal directly, the first instant messaging terminal interacting with the second instant messaging terminal directly,
when the first instant messaging terminal cannot communicate with the second instant messaging terminal directly, the first instant messaging terminal interacting with the second instant messaging terminal by routing information through the messaging server.

4. A second instant messaging terminal, comprising:
a terminal-interacting module that interacts, via an instant messaging application, with a first instant messaging terminal logged into a related account of the application;
the terminal-interacting module comprising:
a sharing request obtaining unit that obtains a data-sharing request transmitted from the first instant messaging terminal,
a reply transmitting unit that responds to the data-sharing request and transmits a reply permitting data sharing to the first instant messaging terminal, the reply comprising an ID collection of at least one shareable data resource, the ID collection of the at least one shareable data resource comprising at least one data resource ID,
a data request obtaining unit that obtains a data-reading request transmitted from the first instant messaging terminal, the data-reading request comprising at least one data resource ID,
a data transmitting unit that transmits, to the first instant messaging terminal, a data resource corresponding to the at least one data resource ID in the data-reading request.

5. The second instant messaging terminal of claim 4, wherein an interaction between the terminal-interacting module and the first instant messaging terminal via the instant messaging application can be direct or routed through a messaging server.

6. The second instant messaging terminal of claim 5, comprising:
a gateway device information uploading module that uploads the gateway device information of the second instant messaging terminal to a messaging server, to allow the messaging server to determine, based on the gateway device information of the first instant messaging terminal and the second instant messaging terminal, whether the first instant messaging terminal and the second instant messaging terminal can connect directly to each other,
when the second instant messaging terminal can connect to the first instant messaging terminal directly, the terminal-interacting module interacting with the first instant messaging terminal directly,
when the second instant messaging terminal cannot connect to the first instant messaging terminal directly, the terminal interacting module interacting with the first instant messaging terminal by routing information through the messaging server.

7. The second instant messaging terminal of claim 6, comprising:
a status-transmitting module that transmits status information of the instant messaging application to the messaging server, to allow the messaging server to determine whether the instant messaging application at the second instant messaging terminal is running in the background,
the sharing request obtaining unit comprising:
a push message obtaining unit that obtains a second push message transmitted by a terminal management server based on a first push message transmitted from the messaging server to the terminal management server, the first push message and the second push message both comprising the data-sharing request transmitted from the first instant messaging terminal,
an activation unit that activates the instant messaging application based on the second push message and obtains the data-sharing request in the second push message.

8. The second instant messaging terminal of claim 4, comprising:
a resource ID obtaining module that generates a data resource ID based on a data resource designated as shareable by a user, obtaining an ID collection associated with the at least one shareable data resource.

9. A messaging server comprising:
an interaction-routing module that routes information for facilitating interactions between the first instant messaging terminal and the second instant communication terminal logged into related accounts,
the interaction-routing module comprising:
a sharing request routing unit that forwards a data-sharing request transmitted from the first instant messaging terminal to the second instant messaging terminal,
a reply routing unit that obtains a reply permitting data sharing from the second instant messaging terminal and forwards the reply to the first instant messaging terminal, the reply comprising an ID collection of at least one shareable data resource, the ID collection of the at least one shareable data resource comprising at least one data resource ID,
a data request routing unit that obtains a data-reading request transmitted from the first instant messaging terminal and forwards the data-reading request to the second instant messaging terminal, the data-reading request comprising at least one data resource ID,
a data routing unit that obtains the data resource corresponding to the data resource ID in the data-reading request and transmitted from the second instant messaging terminal and forwards the data resource to the first instant messaging terminal.

10. The messaging server of claim 9, comprising:
a gateway device information obtaining module that obtains gateway device information uploaded by the first instant messaging terminal and the second instant messaging terminal,
a direct connection determination module that determines, based on the gateway device information of the first instant messaging terminal and the second instant messaging terminal, whether the first instant messaging terminal and the second instant messaging terminal can connect directly to each other,
a direct connection determination transmitting module that transmits, to the first instant messaging terminal, the determination of whether the first instant messaging terminal and the second instant messaging terminal can connect directly to each other.

11. The messaging server of claim 9, comprising:
a status determination module that obtains status information of the instant messaging application of the second instant messaging terminal and determines, based on the status information, whether the instant messaging application of the second instant messaging terminal is running in the background,
the data-sharing request routing unit comprising:
a sharing request obtaining unit that obtains a data sharing request directed to the second instant messaging terminal and transmitted from the first instant messaging terminal,
a push message transmitting unit that, when the status determination module determines that the instant messaging application of the second instant messaging terminal is running in the background, transmits a first push message including the data-sharing request to a terminal management server, to allow the terminal management server to transmit a second push message including the data-sharing request to the second instant messaging terminal, and to ultimately allow the second instant messaging terminal to activate the instant messaging application and obtain the data-sharing request from the second push message.

12. A data-requesting method executed on a first terminal comprising:
receiving a user input requesting data from a second terminal communicating with the first terminal via a communication application,
transmitting, in response to the user input, a data-sharing request to the second terminal via the communication application,
receiving, in response to the data-sharing request, via the communication application from the second terminal, a reply comprising at least one data resource ID corresponding to a data resource at the second terminal,
transmitting, in response to the reply, via the communication application to the second terminal, a data-reading request to the second instant messaging terminal, the data-reading request comprising at least one data resource ID, and
receiving, in response to the data-reading request, via the communication application from the second terminal, a data resource corresponding to the at least one data resource ID in the data-reading request.

13. The method of claim 12, wherein the communication application comprises an instant messaging application, and wherein the first terminal and the second terminal are logged into related accounts of the instant messaging application.

14. The method of claim 13, wherein the related accounts comprise the same account.

15. The method of claim 13, wherein the related accounts comprise accounts associated with a same group.

16. The method of claim 12, comprising:
uploading gateway device information to a messaging server supporting the communication application,
obtaining from the messaging server a determination, based on the gateway device information, whether the first terminal and the second terminal can connect directly to each other,
when the first terminal can connect to the second terminal directly, the first terminal interacting with the second terminal directly,
when the first terminal cannot communicate with the second terminal directly, the first terminal communicating with the second terminal by routing information through the messaging server.

17. The method of claim 12, comprising viewing the received data resource using an application running on the first terminal, wherein the data resource comprising video data.

18. The method of claim 12, comprising receiving a user input selecting at least one data resource ID in the received reply, the at least one data resource designating at least one data resource to be obtained from the second terminal.

19. A data-sharing method executed by a second terminal, comprising:
receiving a data-sharing request from a first terminal via a communication application,
transmitting a reply to the first terminal via the communication application in response to the data-sharing request, the reply comprising at least one shareable data resource ID corresponding to at least one data resource at the second terminal,
receiving a data-reading request from the first terminal via the communication application in response to transmitting the reply, the data-reading request comprising at least one data resource ID, and
transmitting to the first terminal via the communication application a data resource corresponding to the at least one data resource ID in the data-reading request.

20. The method of claim 19, wherein the communication application comprises an instant messaging application, and wherein the first terminal and the second terminal are logged into related accounts of the instant messaging application.

21. The method of claim 19, comprising:
uploading gateway device information to a messaging server supporting the communication application,
obtaining from the messaging server a determination whether the first terminal and the second terminal can connect directly to each other,
when the first terminal can connect to the second terminal directly, the first terminal interacting with the second terminal directly, and
when the first terminal cannot communicate with the second terminal directly, the first terminal communicating with the second terminal by routing information through the messaging server.

22. The method of claim 19, comprising:
transmitting to the messaging server status information of the communication application at the second server,
if the status information indicating the communication application is running in the background at the second terminal, receiving a push message from the messaging server, the push message comprising the data-sharing request, changing an status of the communication application in response to the push message, and extracting the data-sharing request from the push message.

23. The method of claim 19, comprising:
receiving an user input designating a data resource as shareable, and
generating a data resource ID for the designated data resource.
